(19) United States
(12) Patent Application Publication
(10) Pub. No.: US 2026/0302344 A1
(43) Pub. Date: Oct. 1, 2026

(54) METHOD FOR MANUFACTURING SOLID ELECTROLYTE SHEET, AND SOLID ELECTROLYTE SHEET

(71) Applicant: HONDA MOTOR CO., LTD., Tokyo (JP)

(72) Inventors: Hiroshi Sakai, Wako-shi (JP); Takehiro Fukushima, Wako-shi (JP); Mika Mochizuki, Wako-shi (JP)

(21) Appl. No.: 19/550,389

(22) Filed: Feb. 26, 2026

(30) Foreign Application Priority Data
Mar. 31, 2025 (JP) 2025-059046

(51) Int. Cl. H01M 10/0562

(52) U.S. Cl. CPC H01M 10/0562; H01M 2300/0071

(57) ABSTRACT

A method for manufacturing a solid electrolyte sheet filled with a solid electrolyte includes: a first step of applying a slurry containing a solid electrolyte to one surface of a base material conveyed by a roll-to-roll process; a second step of impregnating a three-dimensional structure including a nonwoven fabric into a coating film made of the slurry; and a third step of forming a solid electrolyte layer including the three-dimensional structure by drying the coating film to obtain a solid electrolyte sheet filled with the solid electrolyte.

### CROSS-REFERENCE TO RELATED APPLICATION

Priority is claimed on Japanese Patent Application No. 2025-059046, filed on Mar. 31, 2025, the contents of which are incorporated herein by reference.

### BACKGROUND

### Field of the Invention

The present invention relates to a method for manufacturing a solid electrolyte sheet, and a solid electrolyte sheet.

### Background

Lithium secondary batteries using a solid electrolyte have advantages in that they offer excellent battery safety, are highly reliable because no electrolyte leakage occurs, and can be easily made thinner. In addition, since lithium metal can be used as a negative electrode in lithium secondary batteries using a solid electrolyte, the energy density can be improved, and thus application to high-capacity secondary batteries for electric vehicles or the like is expected.

Regarding a method for manufacturing a solid electrolyte film, for example, a method is known that includes a step of preparing a laminated structure by sequentially laminating a first protective layer, a film-shaped first solid electrolyte material, a porous base material, a film-shaped second solid electrolyte material, and a second protective layer; a step of pressurizing the laminated structure to press the first solid electrolyte material and the second solid electrolyte material into the porous base material so as to fill pores of the porous base material with the first and second solid electrolyte materials; and a step of removing the first protective layer and the second protective layer, in which the pressurization is performed by a roll press method (for example, refer to Japanese Patent No. 7168762).

### SUMMARY

In a method for manufacturing a solid electrolyte sheet having a solid electrolyte film, when a solid electrolyte film is formed by applying a slurry containing a solid electrolyte to one surface of a sheet-shaped base material conveyed by a roll-to-roll process, since the solid electrolyte film alone has a low film strength, the solid electrolyte film may be broken or chipped. Therefore, it has been difficult to form a solid electrolyte film with predetermined size (area) and thickness.

An aspect of the present invention aims to provide a method for manufacturing a solid electrolyte sheet, and a solid electrolyte sheet, in which breakage or chipping of a solid electrolyte layer in manufacturing of a solid electrolyte sheet by a roll-to-roll process is curbed.

The aspect of the present invention will ultimately contribute to energy efficiency.

According to a first aspect of the present invention, there is provided a method for manufacturing a solid electrolyte sheet filled with a solid electrolyte, the method including: a first step of applying a slurry containing a solid electrolyte to one surface of a base material conveyed by a roll-to-roll process; a second step of impregnating a three-dimensional structure including a nonwoven fabric into a coating film made of the slurry; and a third step of forming a solid electrolyte layer including the three-dimensional structure by drying the coating film to obtain a solid electrolyte sheet filled with the solid electrolyte.

According to the foregoing first aspect, the three-dimensional structure supplements the rigidity of the base material, and breakage or chipping of the solid electrolyte layer in manufacturing of a solid electrolyte sheet by a roll-to-roll process can be curbed.

A second aspect is the method for manufacturing a solid electrolyte sheet according to the foregoing first aspect, wherein a tension may be applied to the three-dimensional structure.

According to the foregoing second aspect, the three-dimensional structure can be conveyed with a force that does not cause breakage of the three-dimensional structure.

A third aspect is the method for manufacturing a solid electrolyte sheet according to the foregoing first aspect, wherein the slurry may be intermittently applied to the one surface of the base material, and the three-dimensional structure may be fixed at a position on the one surface of the base material where the slurry is not applied.

According to the foregoing third aspect, the rigidity of the solid electrolyte layer can be supplemented by stopping conveyance of the base material and the three-dimensional structure and laminating the three-dimensional structure on the one surface of the base material.

A fourth aspect is the method for manufacturing a solid electrolyte sheet according to the foregoing first aspect, wherein a speed at which delivery of the three-dimensional structure to a surface of the coating film on a side opposite to the base material is started may be set to a low speed.

According to the foregoing fourth aspect, the three-dimensional structure can be disposed along the one surface of the coating film made of the slurry.

A fifth aspect is the method for manufacturing a solid electrolyte sheet according to the foregoing first aspect, wherein the three-dimensional structure may be fixed to the one surface of the base material with an adhesive tape before application of the slurry is started.

According to the foregoing fifth aspect, the rigidity of the solid electrolyte layer can be supplemented. Therefore, breakage or chipping of the solid electrolyte layer in manufacturing of a solid electrolyte sheet by a roll-to-roll process can be curbed.

A sixth aspect is the method for manufacturing a solid electrolyte sheet according to the foregoing first aspect, wherein the three-dimensional structure may be fed when the slurry is applied.

According to the foregoing sixth aspect, an equivalent mixed state can be achieved without attaching a tape by feeding a nonwoven fabric to a slurry coating surface before drying instead of a tape-attaching method.

A seventh aspect is the method for manufacturing a solid electrolyte sheet according to the foregoing first aspect, wherein immediately before the coating film and the three-dimensional structure come into contact with each other, an angle formed between a surface of the coating film on a side opposite to the base material and the three-dimensional structure may be an acute angle.

According to the foregoing seventh aspect, the three-dimensional structure can be disposed along the one surface of the coating film made of the slurry.

An eighth aspect is the method for manufacturing a solid electrolyte sheet according to the foregoing first aspect, wherein immediately before the coating film and the three-dimensional structure come into contact with each other, an angle formed between the one surface of the base material and the three-dimensional structure may be an acute angle.

According to the foregoing eighth aspect, the three-dimensional structure can be disposed along the one surface of the coating film made of the slurry.

A ninth aspect is the method for manufacturing a solid electrolyte sheet according to the foregoing first aspect, wherein the three-dimensional structure may be a nonwoven fabric.

According to the foregoing ninth aspect, the rigidity lacking in the solid electrolyte layer can be supplemented.

According to a tenth aspect, there is provided a solid electrolyte sheet filled with a solid electrolyte, including: a sheet-shaped three-dimensional structure disposed at a center in a thickness direction and internally filled with a solid electrolyte; and a solid electrolyte layer formed so as to cover each of a front surface and a rear surface of the three-dimensional structure.

According to the foregoing tenth aspect, the three-dimensional structure supplements the rigidity of the solid electrolyte layer, and breakage or chipping of the solid electrolyte layer can be curbed.

An eleventh aspect is the solid electrolyte sheet according to the foregoing tenth aspect, wherein the three-dimensional structure may be a nonwoven fabric.

According to the foregoing eleventh aspect, the rigidity lacking in the solid electrolyte layer can be supplemented.

According to the aspects of the present invention, it is possible to provide a method for manufacturing a solid electrolyte sheet reinforced with a three-dimensional structure in manufacturing of a solid electrolyte sheet by a roll-to-roll process, and the solid electrolyte sheet.

### BRIEF DESCRIPTION OF THE DRAWINGS

FIG. 1 is a schematic view showing a solid electrolyte sheet manufacturing apparatus used in a method for manufacturing a solid electrolyte sheet according to an embodiment of the present invention.

FIG. 2 is a cross-sectional view showing the solid electrolyte sheet according to the embodiment of the present invention.

FIG. 3 is another schematic view showing the solid electrolyte sheet manufacturing apparatus used in the method for manufacturing a solid electrolyte sheet according to the embodiment of the present invention.

FIG. 4 is another schematic view showing the solid electrolyte sheet manufacturing apparatus used in the method for manufacturing a solid electrolyte sheet according to the embodiment of the present invention.

### DESCRIPTION OF EMBODIMENTS

Hereinafter, embodiments of the present invention will be described.

### [Method for Manufacturing Solid Electrolyte Sheet]

### First Embodiment

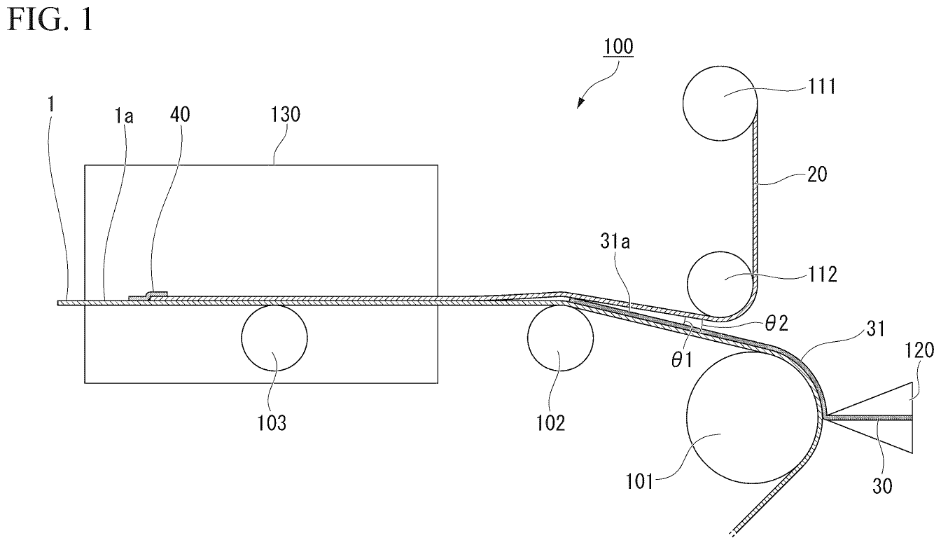

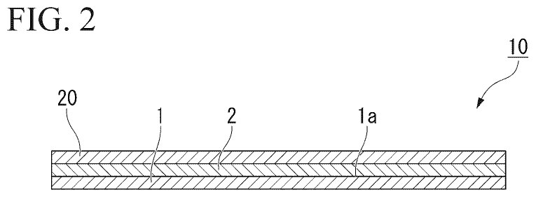

FIG. 1 is a schematic view showing a solid electrolyte sheet manufacturing apparatus used in a method for manufacturing a solid electrolyte sheet of the present embodiment. FIG. 2 is a cross-sectional view showing the solid electrolyte sheet manufactured by the method for manufacturing a solid electrolyte sheet of the present embodiment.

As shown in FIG. 1, a solid electrolyte sheet manufacturing apparatus 100 of the present embodiment is an apparatus for forming a solid electrolyte layer 2 using a three-dimensional structure 20 including a nonwoven fabric on one surface 1a of a base material 1 conveyed by a roll-to-roll process to obtain a solid electrolyte sheet 10 filled with a solid electrolyte shown in FIG. 2.

As shown in FIG. 1, the solid electrolyte sheet manufacturing apparatus 100 of the present embodiment includes a first base material conveyance roll 101, a second base material conveyance roll 102, a third base material conveyance roll 103, a first three-dimensional structure conveyance roll 111, a second three-dimensional structure conveyance roll 112, a coating apparatus 120, and a drying furnace 130. The first base material conveyance roll 101 and the second three-dimensional structure conveyance roll 112 are disposed so as to face each other with the base material 1 and the three-dimensional structure 20 interposed therebetween.

The first base material conveyance roll 101, the second base material conveyance roll 102, and the third base material conveyance roll 103 convey the base material 1.

The first three-dimensional structure conveyance roll 111 and the second three-dimensional structure conveyance roll 112 convey the three-dimensional structure 20.

The coating apparatus 120 applies a slurry 30 containing a solid electrolyte to the one surface 1a of the base material 1.

The drying furnace 130 dries a coating film 31 made of the slurry 30 applied to the one surface 1a of the base material 1.

With reference to FIG. 1, the method for manufacturing a solid electrolyte sheet of the present embodiment will be described.

In the present embodiment, before application of the slurry 30 to the one surface 1a of the base material 1 is started, the three-dimensional structure 20 is fixed to the one surface 1a of the base material 1 with an adhesive tape 40 (second step). A distance from a position where the three-dimensional structure 20 is fixed with the adhesive tape 40 on the base material 1 to a position where application of the slurry 30 is started can preferably be set to 1 m to 10 m.

The base material 1 is not particularly limited, and a sheet-shaped base material made of polyester such as polyethylene terephthalate can be used.

Next, the base material 1 is conveyed by driving the first base material conveyance roll 101, the second base material conveyance roll 102, the third base material conveyance roll 103, and the like, and the three-dimensional structure 20 is conveyed by driving the first three-dimensional structure conveyance roll 111, the second three-dimensional structure conveyance roll 112, and the like. As a result, the base material 1 and the three-dimensional structure 20 are conveyed so as to face each other from a position where the first base material conveyance roll 101 and the second three-dimensional structure conveyance roll 112 face each other.

In conveyance of the three-dimensional structure 20, tension can preferably be applied to the three-dimensional structure 20 by means other than conveyance rolls such as the first base material conveyance roll 101 and the second three-dimensional structure conveyance roll 112. For example, PERMA-TORK (magnetic brake), an electromagnetic brake, or the like can be used as a device for applying tension to the three-dimensional structure 20. PERMA-TORK is a torque control device magnetic utilizing a flow of force lines. The three-dimensional structure 20 is conveyed together with the base material 1 by controlling tension applied to the three-dimensional structure 20 using a device for applying tension. Accordingly, the three-dimensional structure 20 can be conveyed with a force that does not cause breakage of the three-dimensional structure 20. Using a device for applying tension, the tension applied to the three-dimensional structure 20 can preferably be set to 5 N to 20 N and can more preferably be set to 8 N to 10 N. When the tension is within the range, damage to the three-dimensional structure 20 can be curbed.

Immediately before the coating film 31 made of the slurry 30 and the three-dimensional structure 20 come into contact with each other, an angle θ1 formed between a surface (which will hereinafter be referred to as “one surface”) 31a of the coating film 31 on a side opposite to the base material 1 and the three-dimensional structure 20 can preferably be an acute angle, and can preferably be set to 10° to 20°. When the angle θ1 is an acute angle, the three-dimensional structure 20 can be disposed along the one surface 31a of the coating film 31.

Immediately before the coating film 31 made of the slurry 30 and the three-dimensional structure 20 come into contact with each other, an angle θ2 formed between the one surface 1a of the base material 1 and the three-dimensional structure 20 can preferably be an acute angle, and can preferably be set to 20° to 30°. When the angle θ2 is an acute angle, the three-dimensional structure 20 can be disposed along the one surface 1a of the base material 1.

The speed at which delivery of the three-dimensional structure 20 to the one surface 31a of the coating film 31 is started is set to a low speed. The speed at which delivery of the three-dimensional structure 20 is started can preferably be set to a level that does not cause breakage of the three-dimensional structure 20. Accordingly, the three-dimensional structure 20 can be disposed along the one surface 31a of the coating film 31.

The three-dimensional structure 20 is not particularly limited as long as it can supplement the rigidity of the coating film 31 by being laminated and disposed on the one surface 1a of the base material 1 and can be wound together with the base material 1, and it can preferably be a nonwoven fabric. By using a nonwoven fabric, the coating film 31 is impregnated with the nonwoven fabric, and thus the rigidity lacking in the coating film 31 can be supplemented.

Next, as described above, the slurry 30 is applied to the one surface 1a of the base material 1 conveyed by a roll-to-roll process using the coating apparatus 120 (first step). As a result, the coating film 31 made of the slurry 30 is disposed between the base material 1 and the three-dimensional structure 20 at a position where the first base material conveyance roll 101 and the second three-dimensional structure conveyance roll 112 face each other.

The application amount (basis weight) of the slurry 30 with respect to the one surface 1a of the base material 1 can preferably set to 2 mg/cm² to 10 mg/cm², and more preferably set to 3 mg/cm² to 5 mg/cm². When the basis weight is within the range, breakage or chipping of the coating film 31 can be curbed.

The slurry 30 is not particularly limited, and examples thereof include a slurry containing an oxide-based electrolyte or a sulfide-based electrolyte, and a solvent. In addition, as necessary, the slurry 30 may contain other components such as a binder. Next, the coating film 31 is impregnated with the three-dimensional structure 20 (second step).

Next, the solid electrolyte layer 2 including the three-dimensional structure 20 is formed by drying the coating film 31 in the drying furnace 130 to obtain the solid electrolyte sheet 10 filled with a solid electrolyte shown in FIG. 2 (third step).

The temperature for drying the coating film 31 can preferably be set to 50° C. to 150° C. When the temperature is within the range, occurrence of cracking in the solid electrolyte layer 2 can be curbed.

According to the method for manufacturing a solid electrolyte sheet of the present embodiment, the rigidity of the solid electrolyte layer 2 can be supplemented by fixing the three-dimensional structure 20 to the one surface 1a of the base material 1 with the adhesive tape 40 before application of the slurry 30 to the one surface 1a of the base material 1 is started. Therefore, in manufacturing of a solid electrolyte sheet by a roll-to-roll process, breakage or chipping of the solid electrolyte layer 2 can be curbed. In addition, the solid electrolyte layer 2 having a predetermined shape and thickness can be formed on the one surface 1a of the base material 1.

As shown in FIG. 2, the solid electrolyte sheet 10 includes the base material 1, the solid electrolyte layer 2 formed on the one surface 1a of the base material 1, and the three-dimensional structure 20 laminated on an one surface 2a of the solid electrolyte layer 2. The solid electrolyte layer 2 is impregnated with part or all of the three-dimensional structure 20. In addition, FIG. 2 shows a case, as an example, in which the solid electrolyte layer 2 is formed only on a surface (rear surface) 20b of the three-dimensional structure 20 on the solid electrolyte layer 2 side, but the solid electrolyte sheet 10 of the present embodiment is not limited thereto. In the solid electrolyte sheet 10 of the present embodiment, the solid electrolyte layer 2 may be formed on a surface (front surface) 20a of the three-dimensional structure 20 on a side opposite to the solid electrolyte layer 2.

According to the solid electrolyte sheet of the present embodiment, the three-dimensional structure 20 supplements the rigidity of the solid electrolyte layer 2, and therefore breakage or chipping of the solid electrolyte layer 2 can be curbed.

### Second Embodiment

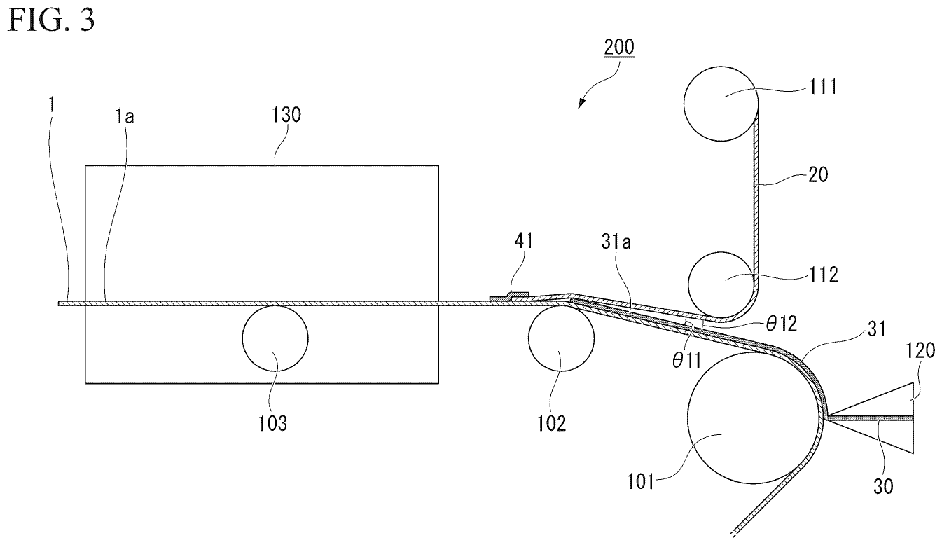

FIG. 3 is a schematic view showing the solid electrolyte sheet manufacturing apparatus used in the method for manufacturing a solid electrolyte sheet of the present embodiment. In FIG. 3, the same reference signs are applied to constituent elements which are the same as the constituent elements shown in FIG. 1, and description thereof will be omitted.

As shown in FIG. 3, a solid electrolyte sheet manufacturing apparatus 200 of the present embodiment is a manufacturing apparatus for forming the solid electrolyte layer 2 on the one surface 1a of the base material 1 conveyed by a roll-to-roll process using the three-dimensional structure 20 including a nonwoven fabric to obtain the solid electrolyte sheet 10 filled with a solid electrolyte shown in FIG. 2.

With reference to FIG. 3, the method for manufacturing a solid electrolyte sheet of the present embodiment will be described.

The base material 1 is conveyed by driving the first base material conveyance roll 101, the second base material conveyance roll 102, the third base material conveyance roll 103, and the like.

Next, as described above, the slurry 30 is applied to the one surface 1a of the base material 1 conveyed by a roll-to-roll process using the coating apparatus 120 (first step).

The application amount (basis weight) of the slurry 30 with respect to the one surface 1a of the base material 1 can preferably be set to 2 mg/cm² to 10 mg/cm², and more preferably be set to 3 mg/cm² to 5 mg/cm². When the basis weight is within the range, breakage or chipping of the coating film 31 can be curbed.

After the slurry 30 is applied to the one surface 1a of the base material 1, conveyance of the base material 1 is temporarily stopped.

Next, the three-dimensional structure 20 is conveyed by driving the first three-dimensional structure conveyance roll 111, the second three-dimensional structure conveyance roll 112, and the like. As a result, the base material 1 and the three-dimensional structure 20 are conveyed so as to face each other from a position where the first base material conveyance roll 101 and the second three-dimensional structure conveyance roll 112 face each other.

In conveyance of the three-dimensional structure 20, tension can preferably be applied to the three-dimensional structure 20 by means other than conveyance rolls such as the first base material conveyance roll 101 and the second three-dimensional structure conveyance roll 112. The device for applying tension to the three-dimensional structure 20 is the same as that of the first embodiment. Using a device for applying tension, the tension applied to the three-dimensional structure 20 can preferably be set to 5 N to 20 N, and can more preferably be set to 8 N to 10 N. When the tension is within the range, damage to the three-dimensional structure 20 can be curbed.

Immediately before the coating film 31 made of the slurry 30 and the three-dimensional structure 20 come into contact with each other, an angle θ11 formed between the surface (which will hereinafter be referred to as “one surface”) 31a of the coating film 31 on a side opposite to the base material 1 and the three-dimensional structure 20 can preferably be an acute angle, and can preferably be set to 10° to 20°. When the angle θ11 is an acute angle, the three-dimensional structure 20 can be disposed along the one surface 31a of the coating film 31.

Immediately before the coating film 31 made of the slurry 30 and the three-dimensional structure 20 come into contact with each other, an angle θ12 formed between the one surface 1a of the base material 1 and the three-dimensional structure 20 can preferably be an acute angle, and can preferably be set to 20° to 30°. When the angle θ12 is an acute angle, the three-dimensional structure 20 can be disposed along the one surface 1a of the base material 1.

The speed at which delivery of the three-dimensional structure 20 to the one surface 31a of the coating film 31 is started is set to a low speed. Accordingly, the three-dimensional structure 20 can be disposed along the one surface 31a of the coating film 31.

The three-dimensional structure 20 can preferably be a nonwoven fabric. By using a nonwoven fabric, the coating film 31 is impregnated with the nonwoven fabric, and thus the rigidity lacking in the coating film 31 can be supplemented.

Next, conveyance of the three-dimensional structure 20 is also stopped, and the three-dimensional structure 20 is fixed to the one surface 1a of the base material 1 with an adhesive tape 41. Accordingly, the coating film 31 is impregnated with the three-dimensional structure 20 (second step). For example, the position where the three-dimensional structure 20 is fixed to the one surface 1a of the base material 1 with the adhesive tape 41 is set to a position near the second base material conveyance roll 102 and where the coating film 31 made of the slurry 30 is not formed. As a result, the coating film 31 made of the slurry 30 is disposed between the base material 1 and the three-dimensional structure 20 at a position where the first base material conveyance roll 101 and the second three-dimensional structure conveyance roll 112 face each other.

Next, after fixing of the three-dimensional structure 20 to the one surface 1a of the base material 1 with the adhesive tape 41 is completed, application of the slurry 30 to the one surface 1a of the base material 1 by the coating apparatus 120 is resumed.

Next, the solid electrolyte layer 2 including the three-dimensional structure 20 is formed by drying the coating film 31 in the drying furnace 130 to obtain the solid electrolyte sheet 10 filled with a solid electrolyte shown in FIG. 2 (third step).

The temperature for drying the coating film 31 can preferably be set to 50° C. to 150° C. When the temperature is within the range, occurrence of cracking in the solid electrolyte layer 2 can be curbed.

According to the method for manufacturing a solid electrolyte sheet of the present embodiment, the rigidity of the solid electrolyte layer 2 can be supplemented by stopping conveyance of the base material 1 and the three-dimensional structure 20 and fixing the three-dimensional structure 20 to the one surface 1a of the base material 1 with the adhesive tape 41. Therefore, in manufacturing of a solid electrolyte sheet by a roll-to-roll process, breakage or chipping of the solid electrolyte layer 2 can be curbed. In addition, the solid electrolyte layer 2 having a predetermined shape and thickness can be formed on the one surface 1a of the base material 1.

### Third Embodiment

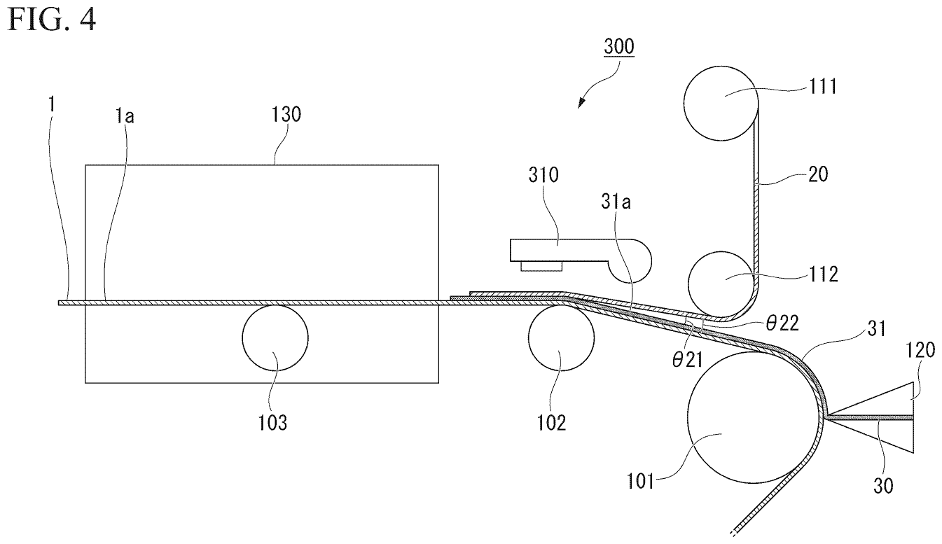

FIG. 4 is a schematic view showing the solid electrolyte sheet manufacturing apparatus used in the method for manufacturing a solid electrolyte sheet of the present embodiment. In FIG. 4, the same reference signs are applied to constituent elements which are the same as the constituent elements shown in FIG. 1, and description thereof will be omitted.

As shown in FIG. 4, a solid electrolyte sheet manufacturing apparatus 300 of the present embodiment is a manufacturing apparatus for forming the solid electrolyte layer 2 on the one surface 1a of the base material 1 conveyed by a roll-to-roll process using the three-dimensional structure 20 including a nonwoven fabric to obtain the solid electrolyte sheet 10 filled with a solid electrolyte shown in FIG. 2.

As shown in FIG. 4, the solid electrolyte sheet manufacturing apparatus 300 of the present embodiment includes the first base material conveyance roll 101, the second base material conveyance roll 102, the third base material conveyance roll 103, the first three-dimensional structure conveyance roll 111, the second three-dimensional structure conveyance roll 112, the coating apparatus 120, the drying furnace 130, and a three-dimensional structure feeding mechanism 310.

The three-dimensional structure feeding mechanism 310 laminates the three-dimensional structure 20 on the one surface 31a of the coating film 31.

With reference to FIG. 4, the method for manufacturing a solid electrolyte sheet of the present embodiment will be described.

The base material 1 is conveyed by driving the first base material conveyance roll 101, the second base material conveyance roll 102, the third base material conveyance roll 103, and the like.

Next, as described above, the slurry 30 is applied to the one surface 1a of the base material 1 conveyed by a roll-to-roll process using the coating apparatus 120 (first step).

The application amount (basis weight) of the slurry 30 with respect to the one surface 1a of the base material 1 can preferably be set to 2 mg/cm² to 10 mg/cm², and more preferably be set to 3 mg/cm² to 5 mg/cm². When the basis weight is within the range, breakage or chipping of the coating film 31 can be curbed.

Next, the three-dimensional structure 20 is conveyed by driving the first three-dimensional structure conveyance roll 111, the second three-dimensional structure conveyance roll 112, and the like. As a result, the base material 1 and the three-dimensional structure 20 are conveyed so as to face each other from a position where the first base material conveyance roll 101 and the second three-dimensional structure conveyance roll 112 face each other. At the time when conveyance of the base material 1 and the three-dimensional structure 20 is started, the base material 1 and the three-dimensional structure 20 are separated, and there is a gap between the base material 1 and the three-dimensional structure 20.

In conveyance of the three-dimensional structure 20, tension can preferably be applied to the three-dimensional structure 20 by means other than conveyance rolls such as the first base material conveyance roll 101 and the second three-dimensional structure conveyance roll 112. The device for applying tension to the three-dimensional structure 20 is the same as that of the first embodiment. Using a device for applying tension, the tension applied to the three-dimensional structure 20 can preferably be set to 5 N to 20 N and can more preferably be set to 8 N to 10 N. When the tension is within the range, damage to the three-dimensional structure 20 can be curbed.

Immediately before the coating film 31 made of the slurry 30 and the three-dimensional structure 20 come into contact with each other, an angle θ21 formed between the surface (which will hereinafter be referred to as “one surface”) 31a of the coating film 31 on a side opposite to the base material 1 and the three-dimensional structure 20 can preferably be an acute angle and can preferably be set to 10° to 20°. When the angle θ21 is an acute angle, the three-dimensional structure 20 can be disposed along the one surface 31a of the coating film 31.

Immediately before the coating film 31 made of the slurry 30 and the three-dimensional structure 20 come into contact with each other, an angle θ22 formed between the one surface 1a of the base material 1 and the three-dimensional structure 20 can preferably be an acute angle, and can preferably be set to 20° to 30°. When the angle θ22 is an acute angle, the three-dimensional structure 20 can be disposed along the one surface 1a of the base material 1.

The speed at which delivery of the three-dimensional structure 20 to the one surface 31a of the coating film 31 is started is set to a low speed. Accordingly, the three-dimensional structure 20 can be disposed along the one surface 31a of the coating film 31.

The three-dimensional structure 20 can preferably be a nonwoven fabric. By using a nonwoven fabric, the coating film 31 is impregnated with the nonwoven fabric, and thus the rigidity lacking in the coating film 31 can be supplemented.

Next, by the three-dimensional structure feeding mechanism 310, the three-dimensional structure 20 is laminated on the one surface 31a of the coating film 31 formed on the base material 1 conveyed by the first base material conveyance roll 101, the second three-dimensional structure conveyance roll 112, and the like. Specifically, the three-dimensional structure feeding mechanism 310 brings the three-dimensional structure 20 into contact with the one surface 31a of the coating film 31, thereby laminating the three-dimensional structure 20 on the one surface 31a of the coating film 31. As a result, the coating film 31 is disposed between the base material 1 and the three-dimensional structure 20 at a position where the second base material conveyance roll 102 and the three-dimensional structure feeding mechanism 310 face each other. Accordingly, the coating film 31 is impregnated with the three-dimensional structure 20 (second step).

Next, the solid electrolyte layer 2 including the three-dimensional structure 20 is formed by drying the coating film 31 in the drying furnace 130 to obtain the solid electrolyte sheet 10 filled with a solid electrolyte shown in FIG. 2 (third step).

The temperature for drying the coating film 31 can preferably be set to 50° C. to 150° C. When the temperature is within the range, occurrence of cracking in the solid electrolyte layer 2 can be curbed.

According to the method for manufacturing a solid electrolyte sheet of the present embodiment, the three-dimensional structure 20 is laminated on the one surface 31a of the coating film 31 formed on the conveyed base material 1. Accordingly, the rigidity of the solid electrolyte layer 2 can be supplemented. Therefore, in manufacturing of a solid electrolyte sheet by a roll-to-roll process, breakage or chipping of the solid electrolyte layer 2 can be curbed. In addition, the solid electrolyte layer 2 having a predetermined shape and thickness can be formed on the one surface 1a of the base material 1.

### Fourth Embodiment

In the present embodiment, similarly to the third embodiment, the solid electrolyte sheet manufacturing apparatus shown in FIG. 4 is used.

With reference to FIG. 4, the method for manufacturing a solid electrolyte sheet of the present embodiment will be described.

The base material 1 is conveyed by driving the first base material conveyance roll 101, the second base material conveyance roll 102, the third base material conveyance roll 103, and the like.

Next, as described above, the slurry 30 is applied to the one surface 1a of the base material 1 conveyed by a roll-to-roll process using the coating apparatus 120 (first step).

The application amount (basis weight) of the slurry 30 with respect to the one surface 1a of the base material 1 can preferably be set to 2 mg/cm² to 10 mg/cm², and more preferably be set to 3 mg/cm² to 5 mg/cm². When the basis weight is within the range, breakage or chipping of the coating film 31 can be curbed.

After the slurry 30 is applied to the one surface 1a of the base material 1, conveyance of the base material 1 is temporarily stopped.

Next, the three-dimensional structure 20 is conveyed by driving the first three-dimensional structure conveyance roll 111, the second three-dimensional structure conveyance roll 112, and the like. As a result, the base material 1 and the three-dimensional structure 20 are conveyed so as to face each other from a position where the first base material conveyance roll 101 and the second three-dimensional structure conveyance roll 112 face each other. At the time when conveyance of the base material 1 and the three-dimensional structure 20 is started, the base material 1 and the three-dimensional structure 20 are separated, and there is a gap between the base material 1 and the three-dimensional structure 20.

In conveyance of the three-dimensional structure 20, tension can preferably be applied to the three-dimensional structure 20 by means other than conveyance rolls such as the first base material conveyance roll 101 and the second three-dimensional structure conveyance roll 112. The device for applying tension to the three-dimensional structure 20 is the same as that of the first embodiment. Using a device for applying tension, the tension applied to the three-dimensional structure 20 can preferably be set to 5 N to 20 N, and can more preferably be set to 8 N to 10 N. When the tension is within the range, damage to the three-dimensional structure 20 can be curbed.

Immediately before the coating film 31 made of the slurry 30 and the three-dimensional structure 20 come into contact with each other, the angle θ21 formed between the surface (which will hereinafter be referred to as “one surface”) 31a of the coating film 31 on a side opposite to the base material 1 and the three-dimensional structure 20 can preferably be an acute angle, and can preferably be set to 10° to 20°. When the angle θ21 is an acute angle, the three-dimensional structure 20 can be disposed along the one surface 31a of the coating film 31.

Immediately before the coating film 31 made of the slurry 30 and the three-dimensional structure 20 come into contact with each other, the angle θ22 formed between the one surface 1a of the base material 1 and the three-dimensional structure 20 can preferably be an acute angle, and can preferably be set to 20° to 30°. When the angle θ22 is an acute angle, the three-dimensional structure 20 can be disposed along the one surface 1a of the base material 1.

The speed at which delivery of the three-dimensional structure 20 to the one surface 31a of the coating film 31 is started is set to a low speed. Accordingly, the three-dimensional structure 20 can be disposed along the one surface 31a of the coating film 31.

The three-dimensional structure 20 can preferably be a nonwoven fabric. By using a nonwoven fabric, the coating film 31 is impregnated with the nonwoven fabric, and thus the rigidity lacking in the coating film 31 can be supplemented.

Next, conveyance of the three-dimensional structure 20 is also stopped, and the three-dimensional structure 20 is laminated on the one surface 31a of the coating film 31 formed on the base material 1 by the three-dimensional structure feeding mechanism 310. Specifically, the three-dimensional structure feeding mechanism 310 brings the three-dimensional structure 20 into contact with the one surface 31a of the coating film 31, thereby laminating the three-dimensional structure 20 on the one surface 31a of the coating film 31. As a result, the coating film 31 is disposed between the base material 1 and the three-dimensional structure 20 at a position where the second base material conveyance roll 102 and the three-dimensional structure feeding mechanism 310 face each other. Accordingly, the coating film 31 is impregnated with the three-dimensional structure 20 (second step).

Next, after lamination of the three-dimensional structure 20 on the one surface 31a of the coating film 31 by the three-dimensional structure feeding mechanism 310 is completed, application of the slurry 30 to the one surface 1a of the base material 1 by the coating apparatus 120 is resumed.

Next, the solid electrolyte layer 2 including the three-dimensional structure 20 is formed by drying the coating film 31 in the drying furnace 130 to obtain the solid electrolyte sheet 10 filled with a solid electrolyte shown in FIG. 2 (third step).

The temperature for drying the coating film 31 can preferably be set to 50° C. to 150° C. When the temperature is within the range, occurrence of cracking in the solid electrolyte layer 2 can be curbed.

According to the method for manufacturing a solid electrolyte sheet of the present embodiment, the rigidity of the solid electrolyte layer 2 can be supplemented by stopping conveyance of the base material 1 and the three-dimensional structure 20 and laminating the three-dimensional structure 20 on the one surface 1a of the base material 1 by the three-dimensional structure feeding mechanism 310. Therefore, in manufacturing of a solid electrolyte sheet by a roll-to-roll process, breakage or chipping of the solid electrolyte layer 2 can be curbed. In addition, the solid electrolyte layer 2 having a predetermined shape and thickness can be formed on the one surface 1a of the base material 1.

Hereinabove, embodiments of the present invention have been described in detail, but the present invention is not limited to the foregoing embodiments, and various modifications and changes can be made within the scope of the gist of the present invention as set forth in the claims.

### EXAMPLES

Hereinafter, the present invention will be described more specifically by way of examples. However, the present invention is not limited to the following examples.

### Example 1

Similarly to the first embodiment described above, a solid electrolyte sheet was manufactured.

The conveyance speed of the base material and the nonwoven fabric was set to 10 m/min.

A slurry containing alumina and an organic solvent for dispersing alumina was used.

The tension applied to the nonwoven fabric was set to 9 N.

The distance from a position where a three-dimensional structure was fixed to the base material with an adhesive tape to a position where application of the slurry was started, that is, the distance over which the base material was conveyed without applying the slurry (non-application conveyance distance), was set to 1 m, 5 m, or 10 m.

The temperature for drying the three-dimensional structure and the coating film was set to 100° C. or 120° C.

Under each condition shown in Table 1, when the solid electrolyte sheet was manufactured, whether wrinkles occurred in the base material was visually confirmed. The results are shown in Table 1.

TABLE 1

| TEST No. | #1 | #2 | #3 | #4 | #5 | #6 |
|---|---|---|---|---|---|---|
| CONVEYANCE | 10 | | | | | |
| SPEED(m/min) | | | | | | |
| NONWOVEN | 9 | | | | | |
| FABRIC | | | | | | |
| CONVEYANCE | | | | | | |
| TENSION(N) | | | | | | |
| DRYING | 100 | | | 120 | | |
| TEMPERA- | | | | | | |
| TURE(° C.) | | | | | | |
| NON-COATED | 1 | 5 | 10 | 1 | 5 | 10 |
| CONVEYANCE | | | | | | |
| DISTANCE(m) | | | | | | |
| CONVEYANCE | NO | NO | NO | NO | NO | NO |
| STATE | BREAK- | BREAK- | BREAK- | BREAK- | BREAK- | BREAK- |
| | AGE | AGE | AGE | AGE | AGE | AGE |

From the results shown in Table 1, it was confirmed that wrinkles did not occur in the base material in any of Test Nos. #1 to #6.

### Example 2

Similarly to the fourth embodiment described above, a solid electrolyte sheet was manufactured.

The conveyance speed of the base material and the nonwoven fabric was set to 10 m/min.

A slurry containing alumina and an organic solvent for dispersing alumina was used.

The tension applied to the nonwoven fabric was set to 9 N.

The temperature for drying the three-dimensional structure and the coating film was set to 100° C. or 120° C.

With respect to a case where a nonwoven fabric was laminated on one surface of the coating film made of the slurry by the three-dimensional structure feeding mechanism in a state where the nonwoven fabric was stretched (feeding shown in Table 2), and a case where a nonwoven fabric was laminated on one surface of the coating film made of the slurry by the three-dimensional structure feeding mechanism in a state where the nonwoven fabric was rolled (rolled feeding shown in Table 2), it was visually confirmed whether wrinkles occurred in the base material when a solid electrolyte sheet was manufactured under each condition shown in Table 2. The results are shown in Table 2.

TABLE 2

| | FEEDING | ROLLED FEEDING | |
|---|---|---|---|
| CONVEYANCE SPEED (m/min) | 10 | | |
| NONWOVEN FABRIC | 9 | | |
| CONVEYANCE TENSION (N) | | | |
| DRYING TEMPERATURE (° C.) | 120 | 100 | |
| NON-COATED | NONE | | |
| CONVEYANCE DISTANCE (m) | | | |
| BASIS WEIGHT (mg/cm²) | 3.6 | 1.7 | 2.9 |

From the results shown in Table 2, it was confirmed that wrinkles did not occur in the base material in both the feeding case and the rolled feeding case.

What is claimed is:

1. A method for manufacturing a solid electrolyte sheet filled with a solid electrolyte, the method comprising:
a first step of applying a slurry containing a solid electrolyte to one surface of a base material conveyed by a roll-to-roll process;
a second step of impregnating a three-dimensional structure including a nonwoven fabric into a coating film made of the slurry; and
a third step of forming a solid electrolyte layer including the three-dimensional structure by drying the coating film to obtain a solid electrolyte sheet filled with the solid electrolyte.

2. The method for manufacturing a solid electrolyte sheet according to claim 1,
wherein a tension is applied to the three-dimensional structure.

3. The method for manufacturing a solid electrolyte sheet according to claim 1,
wherein the slurry is intermittently applied to the one surface of the base material, and the three-dimensional structure is fixed at a position on the one surface of the base material where the slurry is not applied.

4. The method for manufacturing a solid electrolyte sheet according to claim 1,
wherein a speed at which delivery of the three-dimensional structure to a surface of the coating film on a side opposite to the base material is started is set to a low speed.

5. The method for manufacturing a solid electrolyte sheet according to claim 1,
wherein the three-dimensional structure is fixed to the one surface of the base material with an adhesive tape before application of the slurry is started.

6. The method for manufacturing a solid electrolyte sheet according to claim 1,
wherein the three-dimensional structure is fed when the slurry is applied.

7. The method for manufacturing a solid electrolyte sheet according to claim 1,
wherein immediately before the coating film and the three-dimensional structure come into contact with each other, an angle formed between a surface of the coating film on a side opposite to the base material and the three-dimensional structure is an acute angle.

8. The method for manufacturing a solid electrolyte sheet according to claim 1,
wherein immediately before the coating film and the three-dimensional structure come into contact with each other, an angle formed between the one surface of the base material and the three-dimensional structure is an acute angle.

9. The method for manufacturing a solid electrolyte sheet according to claim 1,
wherein the three-dimensional structure is a nonwoven fabric.

10. A solid electrolyte sheet filled with a solid electrolyte, comprising:
a sheet-shaped three-dimensional structure disposed at a center in a thickness direction and internally filled with a solid electrolyte; and
a solid electrolyte layer formed so as to cover each of a front surface and a rear surface of the three-dimensional structure.

11. The solid electrolyte sheet according to claim 10,
wherein the three-dimensional structure is a nonwoven fabric.
